(19) United States
(12) Patent Application Publication
(10) Pub. No.: US 2025/0328182 A1
(43) Pub. Date: Oct. 23, 2025

(54) Adaptive Configuration-Aware Frequency Adjustment of a Processor

(71) Applicants: Nan WANG, Shanghai (CN); Jiang YU, Shanghai (CN); Long CUI, Shanghai (CN); Don C. SOLTIS JR., Timnath, CO (US); Wen KONG, Beijing (CN); Haifeng GONG, Shanghai (CN)

(72) Inventors: Nan WANG, Shanghai (CN); Jiang YU, Shanghai (CN); Long CUI, Shanghai (CN); Don C. SOLTIS JR., Timnath, CO (US); Wen KONG, Beijing (CN); Haifeng GONG, Shanghai (CN)

(21) Appl. No.: 19/257,557

(22) Filed: Jul. 2, 2025

(30) Foreign Application Priority Data
Jul. 2, 2024 (WO) PCT/CN2024/103044

(51) Int. Cl. G06F 1/324

(52) U.S. Cl. CPC G06F 1/324

(57) ABSTRACT

A system and method for dynamically adjusting a frequency of a processor. A connection status of input/output (I/O) interfaces of a processor is determined. An amount of power that can be saved is determined based on the connection status of the I/O interfaces. A frequency of the processor is then adjusted based on the amount of power that can be saved. The frequency of the processor may be adjusted based on a power frequency mapping table which includes various power levels and corresponding frequency values. The processor may be configured with a default frequency and the default frequency is adjusted based on the amount of power that can be saved. The connection status of the I/O interfaces may be determined, and the frequency of the processor may be adjusted accordingly, during boot up of the processor or during runtime of the processor.

### BACKGROUND

Workload performance may be heavily dependent on a core frequency of a central processing unit (CPU). The frequency of the CPU is closely linked to the CPU power budget, particularly the power budget allocated to the cores of the CPU. In the definition and calibration process of CPU frequency (e.g., P0n and P1), a certain amount of power is reserved out of the CPU power budget for different subsystems, such as the input/output (I/O) subsystem. However, the I/O subsystems may not be fully utilized, and the allocated power budget for the I/O subsystem may be saved. In conventional systems, the saved power budget cannot be translated into an increase in the core frequency, and the CPU continues to maintain the original frequency values (e.g., P0n and P1).

### BRIEF DESCRIPTION OF THE FIGURES

Some examples of apparatuses and/or methods will be described in the following by way of example only, and with reference to the accompanying figures, in which

FIG. 1 is a block diagram of an example processor;

FIG. 2 is a flow chart of an example process for adaptive configuration-aware (ACA) frequency adjustment of a processor;

FIG. 3 is a block diagram of an electronic apparatus incorporating the processor and/or the method described herein;

FIG. 4 illustrates a computing device in accordance with one implementation of the disclosed embodiments; and

FIG. 5 shows an example of a higher-level device application for the disclosed embodiments.

### DETAILED DESCRIPTION

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some particular examples thereof are shown in the figures and will subsequently be described in detail. However, this detailed description does not limit further examples to the particular forms described. Further examples may cover all modifications, equivalents, and alternatives falling within the scope of the disclosure. Like numbers refer to like or similar elements throughout the description of the figures, which may be implemented identically or in modified form when compared to one another while providing for the same or a similar functionality.

It will be understood that when an element is referred to as being “connected” or “coupled” to another element, the elements may be directly connected or coupled or via one or more intervening elements. If two elements A and B are combined using an “or”, this is to be understood to disclose all possible combinations, i.e. only A, only B as well as A and B. An alternative wording for the same combinations is “at least one of A and B”. The same applies for combinations of more than 2 elements.

The terminology used herein for the purpose of describing particular examples is not intended to be limiting for further examples. Whenever a singular form such as “a,” “an” and “the” is used and using only a single element is neither explicitly or implicitly defined as being mandatory, further examples may also use plural elements to implement the same functionality. Likewise, when a functionality is subsequently described as being implemented using multiple elements, further examples may implement the same functionality using a single element or processing entity. It will be further understood that the terms “comprises,” “comprising,” “includes” and/or “including,” when used, specify the presence of the stated features, integers, steps, operations, processes, acts, elements and/or components, but do not preclude the presence or addition of one or more other features, integers, steps, operations, processes, acts, elements, components and/or any group thereof.

Unless otherwise defined, all terms (including technical and scientific terms) are used herein in their ordinary meaning of the art to which the examples belong.

In the following description, specific details are set forth, but examples of the technologies described herein may be practiced without these specific details. Well-known circuits, structures, and techniques have not been shown in detail to avoid obscuring an understanding of this description. “An example,” “various examples,” “some examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example,” “in examples,” “in some examples,” and/or “in various examples,” each of which may refer to one or more of the same or different examples. Furthermore, the terms “comprising,” “including,” “having,” and the like, as used with respect to examples of the present disclosure, are synonymous.

Many traditional dual-socket server markets are transitioning towards single-socket configurations, while a portion of the market continues to remain in the form of dual-socket servers. In a single-socket design, the Ultra Path Interconnect (UPI) interface used for interconnecting CPUs will no longer be employed. In a cloud service provider (CSP) generic computing server, which is a mainstream server in CSP with high volume, it only utilizes the Peripheral Component Interconnect Express (PCIe) interfaces for smart network interface card (NIC) and management, with disaggregated storage and virtualized network, and only a few PCIe interfaces are typically utilized. For edge computing servers, the single-socket server in a dense chassis has gained popularity. In the edge computing servers, no UPI connections and fewer PCIe devices are used due to constraints of power and thermal. For blade or micro servers, the server has fewer dual in-line memory modules (DIMMs) and fewer PCIe devices due to space limitation.

Given these application scenarios, it becomes apparent that in many market segments, the CPU I/O interfaces are not being fully utilized. However, the power saved in these scenarios cannot be effectively converted into improvements in CPU frequency. The examples disclosed herein address this problem. In the competitive market landscape, there are challenges in deriving greater benefits based on performance differentials, while keeping the same value of CPU core frequency for the default use case.

The problems discussed above can be addressed in customized CPUs with fewer UPI or PCIe interfaces, as the saved power with the reduced number of UPI or PCIe interfaces can be redirected to enhance the CPU frequency. This approach of customizing CPUs allows for the conversion of saved UPI or PCIe power consumption into an increase in the CPU core frequency. However, this approach presents the following issues. A customized CPU stock keeping unit (SKU) can only be used in specific application scenarios like single-socket or fewer PCIe devices, which results in the creation of additional CPU SKUs and an increase in maintenance costs for both manufacturers and customers. Furthermore, a customized CPU SKU is only for hyperscale customers meeting purchase volume. For other customers, they cannot get such benefits from the standard CPU SKUs which can support single-socket and multi-socket use cases.

Another solution is to define a dedicated single-socket optimized SKU for roadmap SKU for a single-socket use case. However, the solution of dedicated single-socket optimized SKU for roadmap SKU increases SKU stack complexity and corresponding manufacturing and operation cost and locks customers to single socket only use cases.

The above two approaches limit the CPU to a dedicated SKU for specific application scenarios. It results in the loss of flexibility, rendering the CPU unable to adapt to different use cases or configurations.

For double data rate (DDR) interfaces, it needs to support more flexible configurations and there is no similar mechanism to utilize the power saving of the unused ports.

There are I/O power saving features in a current server system. The power saving can contribute to performance increase of CPU cores within the same power envelope. The traditional power saving features can improve CPU core performance. However, the benefits are limited to keeping the same and default base and turbo frequency. The saved power budget cannot be utilized to increase the CPU base and turbo frequency.

Example schemes disclosed herein introduce a novel frequency working mode (which will be referred to as “Adaptive Configuration-Aware mode” (ACA mode)) to boost a processor frequency for performance enhancement, adapting to various I/O usage configurations.

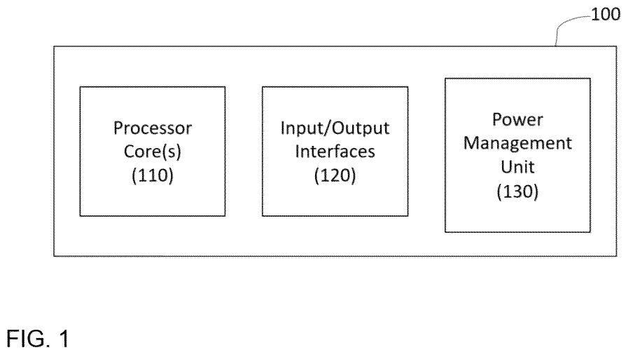

FIG. 1 is a block diagram of an example processor 100. The processor 100 includes a processor core(s) 110, a plurality of I/O interfaces 120, and a power management unit 130. The processor 100 may be a central processing unit (CPU), a graphics processing unit (GPU), a hardware accelerator, or the like. The I/O interfaces 120 (I/O subsystem) is the part of the processor 100 that manages communication between the processor 100 and external devices, such as memory, peripheral devices, network interfaces, other processors or accelerators (e.g., GPUs, Al chips, etc.), and the like. The I/O interfaces 120 may include UPI interfaces, PCIe interfaces, and/or DDR interfaces, etc. UPI is a high-speed, point-to-point interconnect protocol used for processor-to-processor communication in multi-socket systems. PCIe is a high-speed serial interface standard used to connect peripherals such as solid-state devices, network cards, and other devices to the CPU and motherboard. DDR refers to a class of synchronous dynamic random access memory interfaces widely used in computer systems as a main memory interface. The power management unit (P-unit) 130 monitors and controls power delivery to different parts of the processor (cores, I/O subsystem, cache, etc.). The power management unit 130 ensures the processor operates within safe power and thermal limits, and dynamically adjusts voltage, frequency, and power states to balance performance and efficiency.

The processor 100 may operate under a power budget (power limit), and the processor frequency may be scaled within the power budget. The power budget for the processor is shared among multiple internal subsystems. During the processor frequency calibration, the system accounts for the power reserved by these subsystems to avoid exceeding thermal and electrical limits. The processor reserves part of its power budget for I/O interfaces and other sub-systems and the remaining power determines the achievable core frequency.

The operating frequency of the processor 100 is dynamically managed based on its power budget using a combination of hardware and firmware mechanisms. This dynamic management enables the processor 100 to balance performance and power consumption efficiently. The processor may be configured with a base frequency and if a workload spikes, the processor may boost its frequency to a turbo frequency (Turbo boost). Turbo boost allows the processor cores to temporarily exceed the base frequency. For example, a processor with base 2.5 GHz may boost to 4.0 GHz if power budget allows.

In examples, the processor 100 is configured to determine the connection (configuration/utilization) status of the I/O interfaces 120, determine an amount of power that can be saved based on the connection status of the I/O interfaces 120, and adjust the operating frequency of the processor 100 based on the amount of power that can be saved. Not all I/O interfaces of the processor 100 are typically utilized depending on the use case or configuration. In examples, when the ACA mode is enabled, the processor 100 actively monitors the connection status of the I/O interfaces 120, and the power saving from the unused I/O interfaces may be redirected to boost/adjust the frequency of the processor 100.

In examples, the frequency of the processor may be changed/adjusted to a higher frequency than the default frequency (e.g., the base frequency and the turbo frequency) depending on the connection/utilization status of the I/O interfaces. If some I/O interfaces are not connected/configured and utilized, the base frequency and the turbo frequency may be changed to a higher frequency, respectively, (which may be referred to as a P-base-ACA frequency and a P-turbo-ACA frequency). A P-base-ACA frequency is a frequency corresponding to the base frequency that is increased based on the connection status of the I/O interfaces 120, and a P-turbo-ACA frequency is a frequency corresponding to the turbo frequency that is increased based on the connection status of the I/O interfaces 120 during Turbo boost. The processor 100 may load the new frequency mapped to the power savings resulting from the non-utilization of the I/O interfaces 120. When the ACA mode is disabled, the processor 100 may use the default frequency (e.g., the base frequency and the turbo frequency).

In some examples, once the amount of power that can be saved based on the connection status of the I/O interfaces 120 is determined, a signal including the amount of power that can be saved may be sent to a power management unit in the processor 100, and the frequency of the processor may be adjusted by the power management unit based on the signal.

In some examples, the frequency of the processor may be adjusted based on a power frequency mapping table. The power frequency mapping table is a table including various power levels and corresponding frequency values. The P-code may refer to the power frequency mapping table to determine the adjusted frequency for the processor.

In some examples, the processor may be configured with a default frequency and the default frequency is adjusted based on the amount of power that can be saved. The default frequency may be a base frequency and a turbo frequency, and the base frequency and the turbo frequency may be adjusted to a higher frequency, respectively, based on the amount of power that can be saved.

In some examples, the connection status of the I/O interfaces 120 may be determined, and the frequency of the processor may be adjusted accordingly, during boot up of the processor 100 or during runtime of the processor 100.

In some examples, the connection status of the I/O interfaces and the amount of power that can be saved may be determined by a system on chip (SoC) in the processor 100, a basic input/output system (BIOS), or an operating system of the processor 100.

The example schemes disclosed herein provide a mechanism to convert the saved power budget from the unused I/O interfaces into an increased CPU frequency and enhanced performance. The same CPU stock keeping unit (SKU) can operate adaptively at higher frequencies in various scenarios, encompassing single-socket and multi-socket designs, diverse memory configurations, and varying utilization of PCIe interfaces. This approach reduces the number of CPU SKUs, thereby lowering operational and maintenance costs.

The example schemes for adaptive configuration-aware frequency adjustment are explained in detail hereafter. In examples, the ACA mode introduces an adaptive mechanism that dynamically adjusts the processor frequency (e.g., the base and turbo frequencies of a CPU) based on its varying configurations or utilization status of the I/O interfaces of the processor. In examples, the implementation of the ACA mode may comprise three components: a configuration detector, a power-saving calculator, and a power-frequency mapping table.

The configuration detector monitors or assesses the connection or usage status of the I/O interfaces 120 during boot-up or runtime. The I/O interfaces 120 monitored or assessed by the configuration detector may include, but are not limited to, UPI, PCIE, DDR interfaces, or any other I/O interfaces of the processor 100.

The power-saving calculator calculates or determines the amount of power that can be saved based on the input from the configuration detector (i.e., the unused I/O interface status/conditions). For example, a certain amount of power may be allocated for each type and number of I/O interface, and the power-saving calculator may calculate or determine the amount of power that can be saved based on the number and type of the I/O interfaces that are not configured or utilized.

The power-frequency mapping table is a table with different power levels and their corresponding frequency values. The power-frequency mapping table includes entries for the P-base-ACA frequency and P-turbo-ACA frequency. The processor looks up the power-frequency mapping table to determine the increased frequency based on the amount of power that can be saved.

The above functionalities may be executed by the CPU system on chip (SOC) or assisted by the basic input output system (BIOS) or the operating system (OS). An example application method facilitated by BIOS and P-code, as BIOS-assisted implementation, is explained below. In a BIOS-assisted implementation, the ACA mode feature is facilitated and managed with the assistance of the system's BIOS.

During system start-up or runtime, the BIOS actively monitors the I/O connection or utilization status, e.g., the connection or utilization status of UPI, PCIe, and/or DDR interfaces, etc. Runtime detection may be performed for assessing the hot-plug status of PCIe devices, which can be disabled.

Based on the detected I/O connection status, the BIOS computes or determines the amount of power that can be saved (a power saving value). This calculation/determination may involve assessing the extent to which the I/O interfaces (such as UPI, PCIe, and DDR interfaces) are not utilized. For example, the BIOS may detect the number and type of I/O interfaces that are not configured or utilized and determine the power saving value based on the number and type of I/O interfaces that are not configured or utilized.

Once the power saving value is calculated or determined, the BIOS may send a signal, including the calculated power saving value and an ACA trigger signal, to the P-unit of the CPU. The P-unit is responsible for managing power-related functions within the processor.

The P-code in the processor may then reference the power frequency mapping table. A P-code is a microcode, or a firmware-level code used for power management, thermal regulation, and hardware initialization. The P-code may run on a microcontroller embedded in the processor 100. The power frequency mapping table contains various power levels and their corresponding frequency values, e.g., P-base-ACA and P-turbo-ACA frequencies. The P-code uses the power saving value to determine when to trigger a frequency adjustment. If the power saving value reaches or surpasses a specific threshold in the power frequency mapping table, the P-code may dynamically adjust the processor frequency to the new value, such as the P-base-ACA or P-turbo-ACA frequency. This dynamic adjustment optimizes the CPU's performance based on the detected I/O usage/status.

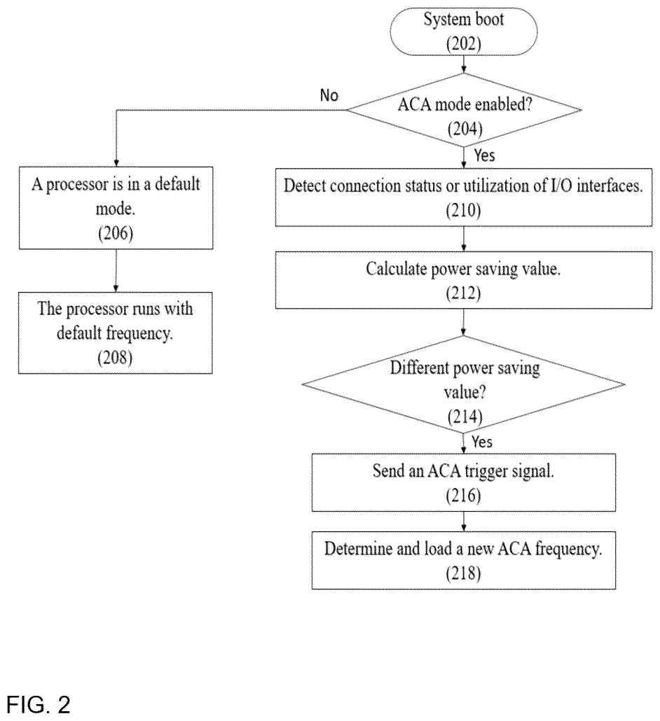

FIG. 2 is a flow chart of an example process for adaptive configuration-aware (ACA) frequency adjustment of a processor. The ACA frequency adjustment process of FIG. 2 may be implemented by the CPU SoC, the BIOS, or the OS.

The system boots up (202). During the system boot-up, it is determined whether the ACA mode is enabled (204). If the ACA mode is not enabled, the processor is in a default mode (206) and runs with a default frequency, e.g., a base frequency or a turbo frequency depending on the turbo boost status (208).

If the ACA mode is enabled, the processor detects the connection status of the I/O interfaces of the processor (210). For example, the BIOS may detect the connection and usage status of the I/O interfaces during system boot-up and runtime. The BIOS may detect the PCIe hot-plug during runtime.

The processor then calculates or determines the power saving value based on the connection status of the I/O interfaces (212). For example, the BIOS may calculate/determine the power saving value based on the connection status of the I/O interfaces (e.g., based on the number and type of the un-used I/O interfaces and the amount of power allocated for each type of I/O interface).

It is then determined whether the power saving value is different from the current value (214). If so, an ACA trigger signal is sent to a P-unit of the processor (216) and a new ACA frequency is determined (e.g., using the power frequency table) and loaded (218). For example, the BIOS may send an ACA trigger signal to the P-unit of the processor with the power saving value. The P-code in the processor may then look up the power frequency mapping table, select a new frequency value for the processor, and load the selected frequency of the processor. For example, the P-code may configure the internal phase-locked loop (PLL) to match this new frequency.

The example schemes disclosed herein provide a novel method to load higher CPU core frequency for performance increase based on the connection status of the I/O interfaces of the processor. In the conventional I/O power saving schemes, the default frequency (e.g., base frequency or turbo frequency) is maintained all the time regardless of the connection/configuration status of the I/O interfaces. In contrast, in the example schemes disclosed herein, the default frequency (e.g., a base frequency or a turbo frequency) is boosted to a higher frequency (e.g., a P-base-ACA frequency or a P-turbo-ACA frequency) based on the connection, configuration, or usage status of the I/O interfaces. In the conventional scheme, power saving to boost CPU frequency is implemented within the pre-configured (fused) frequency range, e.g., base frequency for turbo disabled, and turbo frequency for turbo enabled. In contrast, in the example schemes disclosed herein, the default frequency is boosted further to a higher frequency based on the connection/configuration or usage status of the I/O interfaces. In the example schemes disclosed herein, a processor may be loaded with a new (fused) frequency which is higher than the default base and turbo frequencies for performance enhancement. The conventional server system can only get performance increase with power saving to avoid thermal design power (TDP) limitation. In that case, the benefits may be limited to keeping the same and default base and turbo frequency. In contrast, the example schemes disclosed herein can boost to a higher frequency value converted from the less I/O power consumption.

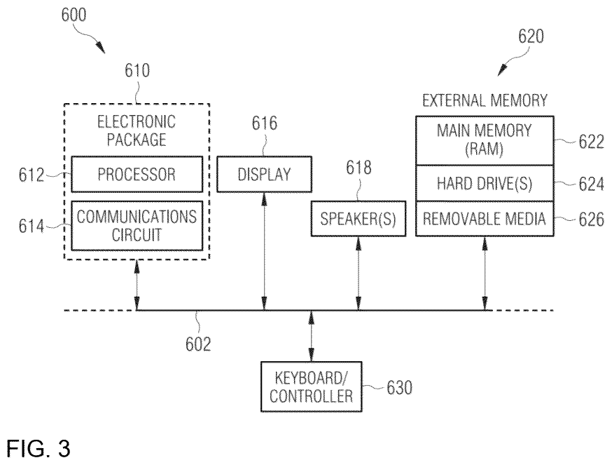

FIG. 3 is a block diagram of an electronic apparatus 600 incorporating the processor and/or the method described herein. Electronic apparatus 600 is-merely one example of an electronic apparatus in which forms of the electronic assemblies and/or methods described herein may be used. Examples of an electronic apparatus 600 include, but are not limited to, personal computers, tablet computers, mobile telephones, game devices, MP3 or other digital music players, etc. In this example, electronic apparatus 600 comprises a data processing system that includes a system bus 602 to couple the various components of the electronic apparatus 600. System bus 602 provides communications links among the various components of the electronic apparatus 600 and may be implemented as a single bus, as a combination of busses, or in any other suitable manner.

An electronic assembly 610 as describe herein may be coupled to system bus 602. The electronic assembly 610 may include any circuit or combination of circuits. In one embodiment, the electronic assembly 610 includes a processor 612 which can be of any type. As used herein, “processor” means any type of computational circuit, such as but not limited to a microprocessor, a microcontroller, a complex instruction set computing (CISC) microprocessor, a reduced instruction set computing (RISC) microprocessor, a very long instruction word (VLIW) microprocessor, a graphics processor, a digital signal processor (DSP), multiple core processor, or any other type of processor or processing circuit.

Other types of circuits that may be included in electronic assembly 610 are a custom circuit, an application-specific integrated circuit (ASIC), or the like, such as, for example, one or more circuits (such as a communications circuit 614) for use in wireless devices like mobile telephones, tablet computers, laptop computers, two-way radios, and similar electronic systems. The IC can perform any other type of function.

The electronic apparatus 600 may also include an external memory 620, which in turn may include one or more memory elements suitable to the particular application, such as a main memory 622 in the form of random access memory (RAM), one or more hard drives 624, and/or one or more drives that handle removable media 626 such as compact disks (CD), flash memory cards, digital video disk (DVD), and the like.

The electronic apparatus 600 may also include a display device 616, one or more speakers 618, and a keyboard and/or controller 630, which can include a mouse, trackball, touch screen, voice-recognition device, or any other device that permits a system user to input information into and receive information from the electronic apparatus 600.

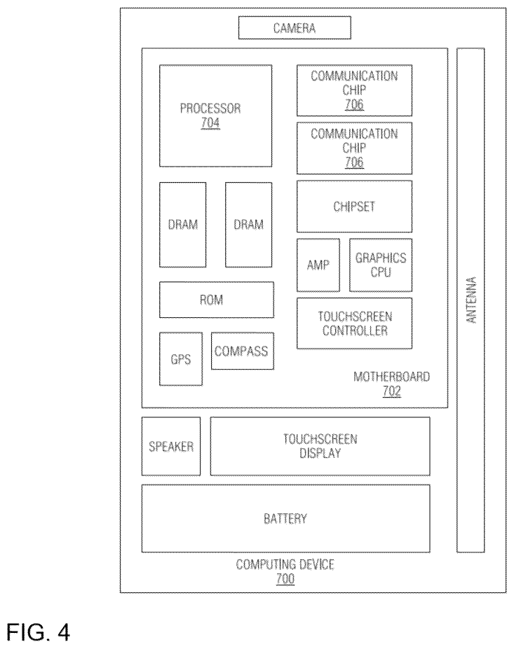

FIG. 4 illustrates a computing device 700 in accordance with one implementation of the disclosed embodiments. The computing device 700 houses a board 702. The board 702 may include a number of components, including but not limited to a processor 704 and at least one communication chip 706. The processor 704 is physically and electrically coupled to the board 702. In some implementations the at least one communication chip 706 is also physically and electrically coupled to the board 702. In further implementations, the communication chip 706 is part of the processor 704. Depending on its applications, computing device 700 may include other components that may or may not be physically and electrically coupled to the board 702. These other components include, but are not limited to, volatile memory (e.g., DRAM), non-volatile memory (e.g., ROM), flash memory, a graphics processor, a digital signal processor, a crypto processor, a chipset, an antenna, a display, a touchscreen display, a touchscreen controller, a battery, an audio codec, a video codec, a power amplifier, a global positioning system (GPS) device, a compass, an accelerometer, a gyroscope, a speaker, a camera, and a mass storage device (such as hard disk drive, compact disk (CD), digital versatile disk (DVD), and so forth). The communication chip 706 enables wireless communications for the transfer of data to and from the computing device 700. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 706 may implement any of a number of wireless standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, derivatives thereof, as well as any other wireless protocols that are designated as 3G, 4G, 5G, and beyond. The computing device 700 may include a plurality of communication chips 706. For instance, a first communication chip 706 may be dedicated to shorter range wireless communications such as Wi-Fi and Bluetooth and a second communication chip 706 may be dedicated to longer range wireless communications such as GPS, EDGE, GPRS, CDMA, WiMAX, LTE, Ev-DO, and others. The processor 704 of the computing device 700 includes an integrated circuit die packaged within the processor 704. In some implementations of the invention, the integrated circuit die of the processor includes one or more devices that are assembled in an ePLB or eWLB based POP package that that includes a mold layer directly contacting a substrate, in accordance with implementations of the invention. The term “processor” may refer to any device or portion of a device that processes electronic data from registers and/or memory to transform that electronic data into other electronic data that may be stored in registers and/or memory. The communication chip 706 also includes an integrated circuit die packaged within the communication chip 706. In accordance with another implementation of the invention, the integrated circuit die of the communication chip includes one or more devices that are assembled in an ePLB or eWLB based POP package that that includes a mold layer directly contacting a substrate, in accordance with implementations of the invention.

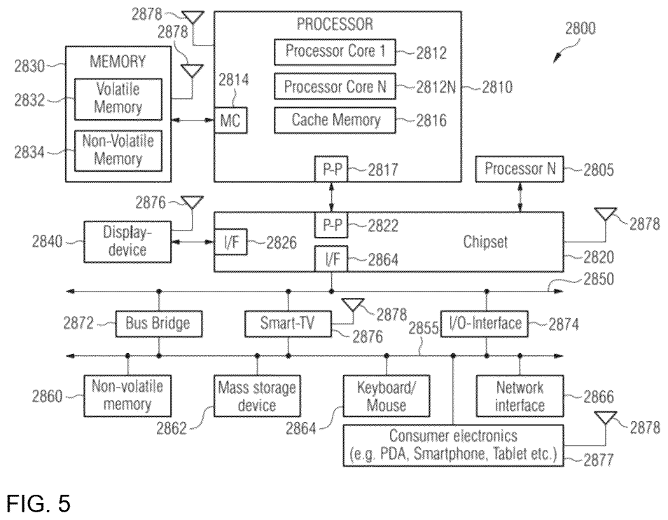

FIG. 5 shows an example of a higher-level device application for the disclosed embodiments. The MAA cantilevered heat pipe apparatus embodiments may be found in several parts of a computing system. In an embodiment, the MAA cantilevered heat pipe is part of a communications apparatus such as is affixed to a cellular communications tower. The MAA cantilevered heat pipe may also be referred to as an MAA apparatus. In an embodiment, a computing system 2800 includes, but is not limited to, a desktop computer. In an embodiment, a system 2800 includes, but is not limited to a laptop computer. In an embodiment, a system 2800 includes, but is not limited to a netbook. In an embodiment, a system 2800 includes, but is not limited to a tablet. In an embodiment, a system 2800 includes, but is not limited to a notebook computer. In an embodiment, a system 2800 includes, but is not limited to a personal digital assistant (PDA). In an embodiment, a system 2800 includes, but is not limited to a server. In an embodiment, a system 2800 includes, but is not limited to a workstation. In an embodiment, a system 2800 includes, but is not limited to a cellular telephone. In an embodiment, a system 2800 includes, but is not limited to a mobile computing device. In an embodiment, a system 2800 includes, but is not limited to a smart phone. In an embodiment, a system 2800 includes, but is not limited to an internet appliance. Other types of computing devices may be configured with the microelectronic device that includes MAA apparatus embodiments.

In an embodiment, the processor 2810 has one or more processing cores 2812 and 2812N, where 2812N represents the Nth processor core inside processor 2810 where N is a positive integer. In an embodiment, the electronic device system 2800 using a MAA apparatus embodiment that includes multiple processors including 2810 and 2805, where the processor 2805 has logic similar or identical to the logic of the processor 2810. In an embodiment, the processing core 2812 includes, but is not limited to, pre-fetch logic to fetch instructions, decode logic to decode the instructions, execution logic to execute instructions and the like. In an embodiment, the processor 2810 has a cache memory 2816 to cache at least one of instructions and data for the MAA apparatus in the system 2800. The cache memory 2816 may be organized into a hierarchal structure including one or more levels of cache memory.

In an embodiment, the processor 2810 includes a memory controller 2814, which is operable to perform functions that enable the processor 2810 to access and communicate with memory 2830 that includes at least one of a volatile memory 2832 and a non-volatile memory 2834. In an embodiment, the processor 2810 is coupled with memory 2830 and chipset 2820. The processor 2810 may also be coupled to a wireless antenna 2878 to communicate with any device configured to at least one of transmit and receive wireless signals. In an embodiment, the wireless antenna interface 2878 operates in accordance with, but is not limited to, the IEEE 802.11 standard and its related family, Home Plug AV (HPAV), Ultra Wide Band (UWB), Bluetooth, WiMax, or any form of wireless communication protocol.

In an embodiment, the volatile memory 2832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. The non-volatile memory 2834 includes, but is not limited to, flash memory, phase change memory (PCM), read-only memory (ROM), electrically erasable programmable read-only memory (EEPROM), or any other type of non-volatile memory device.

The memory 2830 stores information and instructions to be executed by the processor 2810. In an embodiment, the memory 2830 may also store temporary variables or other intermediate information while the processor 2810 is executing instructions. In the illustrated embodiment, the chipset 2820 connects with processor 2810 via Point-to-Point (PtP or P-P) interfaces 2817 and 2822. Either of these PtP embodiments may be achieved using a MAA apparatus embodiment as set forth in this disclosure. The chipset 2820 enables the processor 2810 to connect to other elements in the MAA apparatus embodiments in a system 2800. In an embodiment, interfaces 2817 and 2822 operate in accordance with a PtP communication protocol such as the Intel® QuickPath Interconnect (QPI) or the like. In other embodiments, a different interconnect may be used.

In an embodiment, the chipset 2820 is operable to communicate with the processor 2810, 2805N, the display device 2840, and other devices 2872, 2876, 2874, 2860, 2862, 2864, 2866, 2877, etc. The chipset 2820 may also be coupled to a wireless antenna 2878 to communicate with any device configured to at least do one of transmit and receive wireless signals.

The chipset 2820 connects to the display device 2840 via the interface 2826. The display 2840 may be, for example, a liquid crystal display (LCD), a plasma display, cathode ray tube (CRT) display, or any other form of visual display device. In and embodiment, the processor 2810 and the chipset 2820 are merged into a MAA apparatus in a system. Additionally, the chipset 2820 connects to one or more buses 2850 and 2855 that interconnect various elements 2874, 2860, 2862, 2864, and 2866. Buses 2850 and 2855 may be interconnected together via a bus bridge 2872 such as at least one MAA apparatus embodiment. In an embodiment, the chipset 2820 couples with a non-volatile memory 2860, a mass storage device(s) 2862, a keyboard/mouse 2864, and a network interface 2866 by way of at least one of the interface 2824 and 2874, the smart TV 2876, and the consumer electronics 2877, etc.

In an embodiment, the mass storage device 2862 includes, but is not limited to, a solid state drive, a hard disk drive, a universal serial bus flash memory drive, or any other form of computer data storage medium. In one embodiment, the network interface 2866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the MAA apparatus embodiment in a computing system 2800, the functions performed by some of these blocks may be integrated within a single semiconductor circuit or may be implemented using two or more separate integrated circuits. For example, although cache memory 2816 is depicted as a separate block within processor 2810, cache memory 2816 (or selected aspects of 2816) can be incorporated into the processor core 2812.

Where useful, the computing system 2800 may have a broadcasting structure interface such as for affixing the MAA apparatus to a cellular tower.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions or computer program products as well as any data created and/or used during implementation of the disclosed technologies can be stored on one or more tangible or non-transitory computer-readable storage media, such as volatile memory (e.g., DRAM, SRAM), non-volatile memory (e.g., flash memory, chalcogenide-based phase-change non-volatile memory) optical media discs (e.g., DVDs, CDs), and magnetic storage (e.g., magnetic tape storage, hard disk drives). Computer-readable storage media can be contained in computer-readable storage devices such as solid-state drives, USB flash drives, and memory modules. Alternatively, any of the methods disclosed herein (or a portion) thereof may be performed by hardware components comprising non-programmable circuitry. In some examples, any of the methods herein can be performed by a combination of non-programmable hardware components and one or more processing units executing computer-executable instructions stored on computer-readable storage media.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

As used in this application and the claims, a list of items joined by the term “and/or” can mean any combination of the listed items. For example, the phrase “A, B and/or C” can mean A; B; C; A and B; A and C; B and C; or A, B and C. As used in this application and the claims, a list of items joined by the term “at least one of” can mean any combination of the listed terms. For example, the phrase “at least one of A, B or C” can mean A; B; C; A and B; A and C; B and C; or A, B, and C. Moreover, as used in this application and the claims, a list of items joined by the term “one or more of” can mean any combination of the listed terms. For example, the phrase “one or more of A, B and C” can mean A; B; C; A and B; A and C; B and C; or A, B, and C.

The disclosed methods, apparatuses, and systems are not to be construed as limiting in any way. Instead, the present disclosure is directed toward all novel and nonobvious features and aspects of the various disclosed examples, alone and in various combinations and sub-combinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

Although the operations of some of the disclosed methods are described in a particular, sequential order for convenient presentation, it is to be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Another example is a computer program having a program code for performing at least one of the methods described herein, when the computer program is executed on a computer, a processor, or a programmable hardware component. Another example is a machine-readable storage including machine readable instructions, when executed, to implement a method or realize an apparatus as described herein. A further example is a machine-readable medium including code, when executed, to cause a machine to perform any of the methods described herein.

The examples as described herein may be summarized as follows:
An example (e.g., example 1) relates to a non-transitory machine-readable storage medium including code, when executed, to cause a machine to determine a connection status of input/output (I/O) interfaces of a processor, determine an amount of power that can be saved based on the connection status of the I/O interfaces, and adjust a frequency of the processor based on the amount of power that can be saved.
Another example, (e.g., example 2) relates to a previously described example (e.g., example 1), wherein the frequency of the processor is adjusted based on a power frequency mapping table, the power frequency mapping table including power levels and corresponding frequency values.
Another example, (e.g., example 3) relates to a previously described example (e.g., any one of examples 1-2), wherein the processor is configured with a default frequency and the default frequency is adjusted based on the amount of power that can be saved.
Another example, (e.g., example 4) relates to a previously described example (e.g., example 3), wherein the default frequency includes a base frequency and a turbo frequency, and the base frequency and the turbo frequency are adjusted to a higher frequency, respectively, based on the amount of power that can be saved.
Another example, (e.g., example 5) relates to a previously described example (e.g., any one of examples 1-4), wherein the connection status of the I/O interfaces is determined, and the frequency of the processor is adjusted accordingly, during boot up of the processor.
Another example, (e.g., example 6) relates to a previously described example (e.g., any one of examples 1-5), wherein the connection status of the I/O interfaces is determined, and the frequency of the processor is adjusted accordingly, during runtime of the processor.
Another example, (e.g., example 7) relates to a previously described example (e.g., any one of examples 1-6), wherein the code is to send a signal including the amount of power that can be saved to a power management unit in the processor, wherein the frequency of the processor is adjusted by the power management unit based on the signal.
Another example, (e.g., example 8) relates to a previously described example (e.g., any one of examples 1-7), wherein the connection status of the I/O interfaces and the amount
Another example, (e.g., example 9) relates to a previously described example (e.g., any one of examples 1-8), wherein the I/O interfaces include at least one of Ultra Path Interconnect (UPI), Peripheral Component Interconnect Express (PCIe), or Double Data Rate (DDR) interfaces.
Another example, (e.g., example 10) relates to a processor comprising a processor core, and a plurality of input/output (I/O) interfaces, wherein the processor is configured to determine a connection status of the I/O interfaces, determine an amount of power that can be saved based on the connection status of the I/O interfaces, and adjust a frequency of the processor based on the amount of power that can be saved.
Another example, (e.g., example 11) relates to a previously described example (e.g., example 10), wherein the frequency of the processor is adjusted based on a power frequency mapping table, the power frequency mapping table including power levels and corresponding frequency values.
Another example, (e.g., example 12) relates to a previously described example (e.g., any one of examples 10-11), wherein the processor is configured with a default frequency and the default frequency is adjusted based on the amount of power that can be saved.
Another example, (e.g., example 13) relates to a previously described example (e.g., example 12), wherein the default frequency includes a base frequency and a turbo frequency, and the base frequency and the turbo frequency are adjusted to a higher frequency, respectively, based on the amount of power that can be saved.
Another example, (e.g., example 14) relates to a previously described example (e.g., any one of examples 10-13), wherein the connection status of the I/O interfaces is determined, and the frequency of the processor is adjusted accordingly, during boot up of the processor.
Another example, (e.g., example 15) relates to a previously described example (e.g., any one of examples 10-14), wherein the connection status of the I/O interfaces is determined, and the frequency of the processor is adjusted accordingly, during runtime of the processor.
Another example, (e.g., example 16) relates to a previously described example (e.g., any one of examples 10-15), wherein a signal including the amount of power that can be saved is sent to a power management unit in the processor, and the frequency of the processor is adjusted by the power management unit based on the signal.
Another example, (e.g., example 17) relates to a previously described example (e.g., any one of examples 10-16), wherein the connection status of the I/O interfaces and the amount
Another example, (e.g., example 18) relates to a previously described example (e.g., any one of examples 10-17), wherein the I/O interfaces include at least one of Ultra Path Interconnect (UPI), Peripheral Component Interconnect Express (PCIe), or Double Data Rate (DDR) interfaces.
Another example, (e.g., example 19) relates to a method for dynamically adjusting a frequency of a processor, comprising determining a connection status of input/output (I/O) interfaces of a processor, determining an amount of power that can be saved based on the connection status of the I/O interfaces, and adjusting a frequency of the processor based on the amount of power that can be saved.
Another example, (e.g., example 20) relates to a previously described example (e.g., example 19), wherein the frequency of the processor is adjusted based on a power frequency mapping table, the power frequency mapping table including power levels and corresponding frequency values.
Another example, (e.g., example 21) relates to a previously described example (e.g., any one of examples 19-20), wherein the processor is configured with a default frequency and the default frequency is adjusted based on the amount of power that can be saved.
Another example, (e.g., example 22) relates to a previously described example (e.g., example 21), wherein the default frequency includes a base frequency and a turbo frequency, and the base frequency and the turbo frequency are adjusted to a higher frequency, respectively, based on the amount of power that can be saved.
Another example, (e.g., example 23) relates to a previously described example (e.g., any one of examples 19-22), wherein the connection status of the I/O interfaces is determined, and the frequency of the processor is adjusted accordingly, during boot up of the processor.
Another example, (e.g., example 24) relates to a previously described example (e.g., any one of examples 19-23), wherein the connection status of the I/O interfaces is determined, and the frequency of the processor is adjusted accordingly, during runtime of the processor.
Another example, (e.g., example 25) relates to a previously described example (e.g., any one of examples 19-24), wherein the code is to send a signal including the amount of power that can be saved to a power management unit in the processor, wherein the frequency of the processor is adjusted by the power management unit based on the signal.
Another example, (e.g., example 26) relates to a previously described example (e.g., any one of examples 19-25), wherein the connection status of the I/O interfaces and the amount
Another example, (e.g., example 27) relates to a previously described example (e.g., any one of examples 19-26), wherein the I/O interfaces include at least one of Ultra Path Interconnect (UPI), Peripheral Component Interconnect Express (PCIe), or Double Data Rate (DDR) interfaces.
Another example, (e.g., example 28) relates to a computer program for dynamically adjusting a frequency of a processor, when executed on a processor to cause the processor to determine a connection status of input/output (I/O) interfaces of a processor, determine an amount of power that can be saved based on the connection status of the I/O interfaces, and adjust a frequency of the processor based on the amount of power that can be saved.
Another example, (e.g., example 29) relates to a previously described example (e.g., example 28), wherein the frequency of the processor is adjusted based on a power frequency mapping table, the power frequency mapping table including power levels and corresponding frequency values.
Another example, (e.g., example 30) relates to a previously described example (e.g., any one of examples 28-29), wherein the processor is configured with a default frequency and the default frequency is adjusted based on the amount of power that can be saved.
Another example, (e.g., example 31) relates to a previously described example (e.g., example 30), wherein the default frequency includes a base frequency and a turbo frequency, and the base frequency and the turbo frequency are adjusted to a higher frequency, respectively, based on the amount of power that can be saved.
Another example, (e.g., example 32) relates to a previously described example (e.g., any one of examples 28-31), wherein the connection status of the I/O interfaces is determined, and the frequency of the processor is adjusted accordingly, during boot up of the processor.
Another example, (e.g., example 33) relates to a previously described example (e.g., any one of examples 28-32), wherein the connection status of the I/O interfaces is determined, and the frequency of the processor is adjusted accordingly, during runtime of the processor.
Another example, (e.g., example 34) relates to a previously described example (e.g., any one of examples 28-33), wherein the code is to send a signal including the amount of power that can be saved to a power management unit in the processor, wherein the frequency of the processor is adjusted by the power management unit based on the signal.
Another example, (e.g., example 35) relates to a previously described example (e.g., any one of examples 28-34), wherein the connection status of the I/O interfaces and the amount
Another example, (e.g., example 36) relates to a previously described example (e.g., any one of examples 28-35), wherein the I/O interfaces include at least one of Ultra Path Interconnect (UPI), Peripheral Component Interconnect Express (PCIe), or Double Data Rate (DDR) interfaces.

The aspects and features mentioned and described together with one or more of the previously detailed examples and figures, may as well be combined with one or more of the other examples in order to replace a like feature of the other example or in order to additionally introduce the feature to the other example.

Examples may further be or relate to a computer program having a program code for performing one or more of the above methods, when the computer program is executed on a computer or processor. Steps, operations or processes of various above-described methods may be performed by programmed computers or processors. Examples may also cover program storage devices such as digital data storage media, which are machine, processor or computer readable and encode machine-executable, processor-executable or computer-executable programs of instructions. The instructions perform or cause performing some or all of the acts of the above-described methods. The program storage devices may comprise or be, for instance, digital memories, magnetic storage media such as magnetic disks and magnetic tapes, hard drives, or optically readable digital data storage media. Further examples may also cover computers, processors or control units programmed to perform the acts of the above-described methods or (field) programmable logic arrays ((F) PLAs) or (field) programmable gate arrays ((F) PGAs), programmed to perform the acts of the above-described methods.

The description and drawings merely illustrate the principles of the disclosure. Furthermore, all examples recited herein are principally intended expressly to be only for pedagogical purposes to aid the reader in understanding the principles of the disclosure and the concepts contributed by the inventor(s) to furthering the art. All statements herein reciting principles, aspects, and examples of the disclosure, as well as specific examples thereof, are intended to encompass equivalents thereof.

A functional block denoted as “means for . . . ” performing a certain function may refer to a circuit that is configured to perform a certain function. Hence, a “means for s.th.” may be implemented as a “means configured to or suited for s.th.”, such as a device or a circuit configured to or suited for the respective task.

Functions of various elements shown in the figures, including any functional blocks labeled as “means”, “means for providing a sensor signal”, “means for generating a transmit signal.”, etc., may be implemented in the form of dedicated hardware, such as “a signal provider”, “a signal processing unit”, “a processor”, “a controller”, etc. as well as hardware capable of executing software in association with appropriate software. When provided by a processor, the functions may be provided by a single dedicated processor, by a single shared processor, or by a plurality of individual processors, some of which or all of which may be shared. However, the term “processor” or “controller” is by far not limited to hardware exclusively capable of executing software but may include digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included.

A block diagram may, for instance, illustrate a high-level circuit diagram implementing the principles of the disclosure. Similarly, a flow chart, a flow diagram, a state transition diagram, a pseudo code, and the like may represent various processes, operations or steps, which may, for instance, be substantially represented in computer readable medium and so executed by a computer or processor, whether or not such computer or processor is explicitly shown. Methods disclosed in the specification or in the claims may be implemented by a device having means for performing each of the respective acts of these methods.

It is to be understood that the disclosure of multiple acts, processes, operations, steps or functions disclosed in the specification or claims may not be construed as to be within the specific order, unless explicitly or implicitly stated otherwise, for instance for technical reasons. Therefore, the disclosure of multiple acts or functions will not limit these to a particular order unless such acts or functions are not interchangeable for technical reasons. Furthermore, in some examples a single act, function, process, operation or step may include or may be broken into multiple sub-acts, -functions, -processes, -operations or -steps, respectively. Such sub acts may be included and part of the disclosure of this single act unless explicitly excluded.

Furthermore, the following claims are hereby incorporated into the detailed description, where each claim may stand on its own as a separate example. While each claim may stand on its own as a separate example, it is to be noted that—although a dependent claim may refer in the claims to a specific combination with one or more other claims—other examples may also include a combination of the dependent claim with the subject matter of each other dependent or independent claim. Such combinations are explicitly proposed herein unless it is stated that a specific combination is not intended. Furthermore, it is intended to include also features of a claim to any other independent claim even if this claim is not directly made dependent to the independent claim.

1. A non-transitory machine-readable storage medium including code, when executed, to cause a machine to:
determine a connection status of input/output (I/O) interfaces of a processor;
determine an amount of power that can be saved based on the connection status of the I/O interfaces; and
adjust a frequency of the processor based on the amount of power that can be saved.

2. The non-transitory machine-readable storage medium of claim 1, wherein the frequency of the processor is adjusted based on a power frequency mapping table, the power frequency mapping table including power levels and corresponding frequency values.

3. The non-transitory machine-readable storage medium of claim 1, wherein the processor is configured with a default frequency and the default frequency is adjusted based on the amount of power that can be saved.

4. The non-transitory machine-readable storage medium of claim 3, wherein the default frequency includes a base frequency and a turbo frequency, and the base frequency and the turbo frequency are adjusted to a higher frequency, respectively, based on the amount of power that can be saved.

5. The non-transitory machine-readable storage medium of claim 1, wherein the connection status of the I/O interfaces is determined, and the frequency of the processor is adjusted accordingly, during boot up of the processor.

6. The non-transitory machine-readable storage medium of claim 1, wherein the connection status of the I/O interfaces is determined, and the frequency of the processor is adjusted accordingly, during runtime of the processor.

7. The non-transitory machine-readable storage medium of claim 1, wherein the code is to send a signal including the amount of power that can be saved to a power management unit in the processor, wherein the frequency of the processor is adjusted by the power management unit based on the signal.

8. The non-transitory machine-readable storage medium of claim 1, wherein the connection status of the I/O interfaces and the amount of power that can be saved are determined by a system on chip in the processor, a basic input/output system (BIOS), or an operating system of the processor.

9. The non-transitory machine-readable storage medium of claim 1, wherein the I/O interfaces include at least one of Ultra Path Interconnect (UPI), Peripheral Component Interconnect Express (PCIe), or Double Data Rate (DDR) interfaces.

10. A processor comprising:
a processor core; and
a plurality of input/output (I/O) interfaces,
wherein the processor is configured to:
determine a connection status of the I/O interfaces;
determine an amount of power that can be saved based on the connection status of the I/O interfaces; and
adjust a frequency of the processor based on the amount of power that can be saved.

11. The processor of claim 10, wherein the frequency of the processor is adjusted based on a power frequency mapping table, the power frequency mapping table including power levels and corresponding frequency values.

12. The processor of claim 10, wherein the processor is configured with a default frequency and the default frequency is adjusted based on the amount of power that can be saved.

13. The processor of claim 12, wherein the default frequency includes a base frequency and a turbo frequency, and the base frequency and the turbo frequency are adjusted to a higher frequency, respectively, based on the amount of power that can be saved.

14. The processor of claim 10, wherein the connection status of the I/O interfaces is determined, and the frequency of the processor is adjusted accordingly, during boot up of the processor.

15. The processor of claim 10, wherein the connection status of the I/O interfaces is determined, and the frequency of the processor is adjusted accordingly, during runtime of the processor.

16. The processor of claim 10, wherein a signal including the amount of power that can be saved is sent to a power management unit in the processor, and the frequency of the processor is adjusted by the power management unit based on the signal.

17. The processor of claim 10, wherein the connection status of the I/O interfaces and the amount of power that can be saved are determined by a system on chip in the processor, a basic input/output system (BIOS), or an operating system of the processor.

18. The processor of claim 10, wherein the I/O interfaces include at least one of Ultra Path Interconnect (UPI), Peripheral Component Interconnect Express (PCIe), or Double Data Rate (DDR) interfaces.

19. A method for dynamically adjusting a frequency of a processor, comprising:
determining a connection status of input/output (I/O) interfaces of a processor;
determining an amount of power that can be saved based on the connection status of the I/O interfaces; and
adjusting a frequency of the processor based on the amount of power that can be saved.
